(19) United States
(12) Patent Application Publication
(10) Pub. No.: US 2023/0241778 A1
(43) Pub. Date: Aug. 3, 2023

(54) CONTROL OF A WEARABLE ROBOT

(71) Applicant: President and Fellows of Harvard College, Cambridge, MA (US)

(72) Inventors: Conor J. Walsh, Cambridge, MA (US); Tommaso Proietti, Cambridge, MA (US); Ciarán O'Neill, Cambridge, MA (US)

(73) Assignee: President and Fellows of Harvard College, Cambridge, MA (US)

(21) Appl. No.: 18/081,470

(22) Filed: Dec. 14, 2022

Related U.S. Application Data
(60) Provisional application No. 63/304,303, filed on Jan. 28, 2022.

(51) Int. Cl. B25J 9/16; B25J 9/00; B25J 9/14; B25J 13/08

(52) U.S. Cl. CPC B25J 9/1692; B25J 9/0006; B25J 9/142; B25J 13/088

(57) ABSTRACT

Systems and methods related to the operation of wearable robotic systems are disclosed. In one embodiment, a wearable robotic system may be calibrated by correlating a measured joint angle and an actuation pressure. In another embodiment, a wearable robotic system may be operated to provide gravity compensation by operating one or more actuators of the system based on an estimated current pose of a first body portion associated with a joint and calibration parameters of the system to support at least a portion of a weight of the first body portion.

### CROSS-REFERENCE TO RELATED APPLICATIONS

This application claims priority to U.S. Provisional Application No. 63/304,303, filed Jan. 28, 2022, the contents of which is incorporated herein in its entirety.

### GOVERNMENT SUPPORT

The invention was made with government support under Award 1830896 awarded by the National Science Foundation (NSF). The Government has certain rights in the invention.

### FIELD

Disclosed embodiments are related to robotics, specifically to wearable soft robots.

### BACKGROUND

Assistive wearable robotics is an emerging trend in the domain of robotics. From medical applications (e.g., stroke rehabilitation, spinal cord injury assistance, etc.) to healthy individuals assistance (e.g., to reduce injuries in workplaces, to assist during sport performances, etc.), hundreds of assistive wearable robots have been developed in both universities and industry. Many of these devices are reaching the market and being heavily validated by end-users. Currently, commercial wearable robots are mostly rigidly framed, with either passively or actively actuated joints, and can provide targeted assistance to one or more human body joints simultaneously.

### SUMMARY

In one embodiment, a method of calibrating a wearable robot comprises: adjusting a pressure of a fluidic actuator of the wearable robot; measuring a joint angle of a wearer of the wearable robot while the pressure of the fluidic actuator is adjusted; and correlating the joint angle and the pressure of the fluidic actuator.

In one embodiment, a method of providing gravity compensation for a wearable robot comprises obtaining calibration parameters for the wearable robot, the wearable robot configured to be engaged with first and second body portions of a user on opposing sides of a joint of the user; estimating a current pose of the first body portion relative to the second body portion; and operating one or more actuators based on the estimated current pose and the calibration parameters to support at least a portion of a weight of the first body portion.

In one embodiment, a wearable robotic system includes: a fluidic actuator; a pressure source operatively coupled to the fluidic actuator; one or more sensors configured to measure a pose of a portion of a wearer of the wearable robotic system; and a processor operatively coupled to the pressure source and the one or more sensors, the processor configured to execute any of the above methods.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A depicts one embodiment of a wearable robotic system;

FIG. 1B depicts additional details of the embodiment of a wearable robotic system of FIG. 1A;

FIG. 2 depicts one embodiment of a controller for a wearable robotic system; and

FIG. 3 depicts one embodiment of calibrating a wearable robotic system.

### DETAILED DESCRIPTION

As described above, conventional wearable robots are typically rigid. Shortcomings associated with these rigid robots include their size and weight, the need for careful alignment between the user joints and the robot joints, relatively high cost, and limited portability.

A promising new trend in this field is the creation of assistive wearable robots that use soft actuators to directly engage with the human body and to support its movements. In a soft wearable robot, the wearer's skeletal structure may be considered the frame of the robot. The combination of soft actuation methods, like pneumatic textile-based actuators or cable-driven actuators, and the lack of a rigid frame may address many of the aforementioned limits of rigid robots. The inherent compliance of the actuators may allow for a more direct, safer and natural physical interaction between the users and the robot.

Despite these benefits of assistive wearable robots that use soft actuators, the complexity of sensing and controlling the interaction between the robot and the wearer is dramatically increased due to inherent compliance in the combined system of the soft robotic actuators and the user's body. This interaction is challenging to model due to the many degrees of freedom involved between the soft actuator and the biological tissues of the user. This challenge can be further complicated when dealing with medical applications and impaired populations whose muscle tone and body composition may vary more broadly than a healthy population.

When considering medical applications such as stroke rehabilitation, the most commonly used conventional wearable robots are rigid exoskeletons and rigid manipulanda or end-effector robots. Exoskeletons and manipulanda have been evaluated intensively with large populations of stroke survivors and with randomized controlled trials. However, the improvements in relevant outcome metrics when comparing robotic assisted therapies with conventional therapies are still limited and therefore the advantage of using these devices is still unproven.

The relative portability of soft robots may allow for seamless integration with the clinical environment, favoring the adoption of robotic therapy during simulated activities of daily living (ADL) scenarios. This portability can also potentially allow the robots to be brought into the homes of those in need of therapy, enabling greater therapy engagement and a greater volume and duration of therapy. In fact, limited volume of therapy is considered the number one cause of limited outcomes of the robot-assisted stroke therapy.

The literature of soft wearable assistive and rehabilitation robots is still young and evolving. To date, it is believed that very few devices targeting upper-limb assistance (excluding hand) exist and predominantly assist only a single joint. Many of these robots are cable-driven, targeting either the shoulder, the elbow or the wrist. Multi joint robots have typically assisted both the shoulder and elbow. Many of these devices have been evaluated on healthy participants but very few have been evaluated on any impaired users. A pneumatic shoulder robot recently demonstrated reductions in muscle activity and was shown to improve the average range of motion (ROM) across 6 stroke survivors.

In a study with 5 stroke survivors, it was demonstrated that a pneumatic shoulder robot may both increase their functional ROM while also reducing the fatigue of a therapist when performing rehabilitation exercises. However, the device in that study was manually controlled to modulate the delivered assistance by a member of the research team. Additionally, based on stroke survivor and therapist feedback during that study, it was determined that additional assistance was required at the elbow to fully overcome the flexor synergy, whereby stroke survivors often experience involuntary coupling of shoulder abductor activity with activation of elbow flexors.

In view of the above, the inventors have recognized and appreciated the benefits associated with sensing and dynamic control strategies to facilitate control of a wearable robot. A rigid wearable robot may include a well-defined structure with definite joint locations. As such, conventional rigid wearable robots may take advantage of certain calibration and/or control strategies that employ inverse kinematics. In contrast, a soft wearable robot may not be associated with well-defined structures and/or joint locations. Accordingly, the inventors have appreciated that an experimental approach to calibration and/or control may be more suitable for a soft wearable robot, as described in greater detail below.

In some embodiments, a method of calibrating a wearable robot may include adjusting a pressure of a fluidic actuator of the wearable robot, measuring an angle of a joint of a wearer of the wearable robot while the pressure of the fluidic actuator is adjusted, and correlating the joint angle and the pressure of the fluidic actuator. For example, a first joint angle may be measured when the fluidic actuator is pressurized at a first pressure level, and a second joint angle may be measured when the fluidic actuator is pressurized at a second pressure level. A change from the first joint angle to the second joint angle may be correlated with a change from the first pressure level to the second pressure level. In this way, a desired joint angle may be controlled by pressurizing the fluidic actuator to the appropriate pressure level, as determined by the calibration. Depending on the embodiment, this calibration of pressure versus joint angle may be the same in two actuation directions (e.g., flexion, extension, lifting and lowering, reaching or retraction). However, embodiments in which different calibrations of pressure versus joint angle are used in the different directions (e.g. flexion or extension) or movements (e.g., reaching or lifting) are also contemplated.

In some embodiments, a method of providing gravity compensation for a wearable robot may include receiving calibration parameters for the wearable robot, the calibration parameters determined from a calibration routine. The calibration routine may include a calibration routine similar to the method described above, or may include any other suitable calibration routine. The method of providing gravity compensation may additionally include estimating a current pose of a wearer of the wearable robot (e.g., using one or more sensors), adjusting one or more actuators based on the estimated pose and the calibration parameters. For example, if sensor data indicates that the wearer's arm is held at a particular pose (e.g., shoulder flexion angle), calibration parameters may be analyzed to determine what actuator pressure may be associated with supporting the wearer's arm at that same pose. Then, a state of an actuator may be adjusted (e.g., pressurized or depressurized) to obtain the associated actuator pressure and support the wearer's arm at the specific pose. With the actuator supporting the wearer's arm in that pose, the wearer may be able to maintain the pose exerting little or no effort.

As used herein, the term soft actuator may refer to any actuator that includes flexible, compliant, and/or elastomeric materials and/or structures. For example, a fluidic soft actuator may include an elastomeric body that expands or contracts in response to the change in pressure of a fluid (e.g., air, water) within the elastomeric body. A fluidic soft actuator may alternatively be comprised of the textile outer shell with a fluid-impermeable lining which fold and unfold in response to changes in the fluid pressure within the actuator, or application of external forces and torques. Alternatively, a soft actuator may include a flexible tether (e.g., a cable, wire, or other flexible structure cable of transferring a force) that is driven by a more traditional actuator, such as a motor. It should be appreciated that a soft actuator may include components that are flexible enough such that one or more components of the soft actuator engaged with one or more portions of the user's body deform with, and may conform to, a shape and/or orientation of a portion of the user's body the components are engaged with. For example, one or more flexible straps, cuffs, bladders, and/or any other appropriate component may be flexible enough to conform to a shape and/or orientation of an associated portion of the user's body during operation. In some embodiments, a soft actuator may be controlled by modulating a pressure applied to the soft actuator. In some embodiments, a soft actuator may be controlled by modulating a flow rate of fluid applied to the soft actuator. However, embodiments in which a force applied to a tether is used to provide the desired actuation are also contemplated.

It should be understood that the various methods and systems described herein may be operated to calibrate and operate a system over a plurality of joint angles and a plurality of pressures or other actuation parameters. Additionally, the various methods of operation may be used either for a single joint and/or may be applied to control separate joints of a user either individually and/or in coordination with one another.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

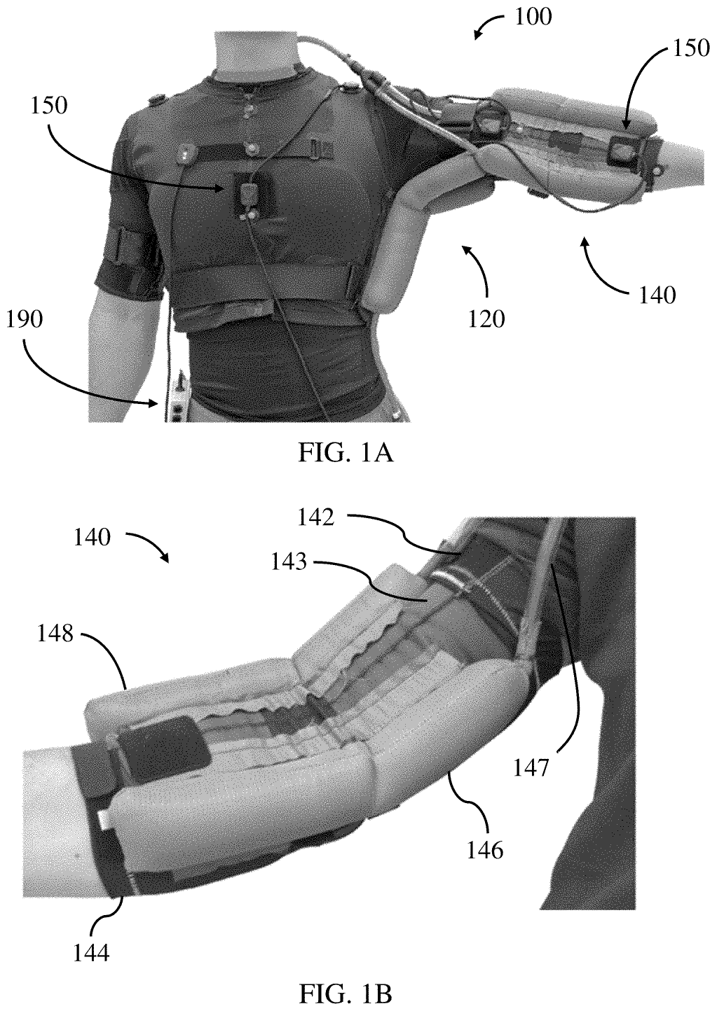

FIG. 1A depicts one embodiment of a wearable robotic system 100. The wearable robotic system 100 includes a shoulder portion 120 and an elbow portion 140. The system 100 additionally includes a controller 190 and a pressure source (not shown) operatively coupled to the actuators (described below) of the robotic system 100. The portability and compliance of the wearable robotic system may allow for the robot to be used safely outside of clinical settings, where the robot can be donned by untrained caregivers as accurate alignment may not be needed due to the inherent compliance of the robot. The shoulder portion may be made by a single or multiple chambers, assisting a single or multiple degrees of freedom and thus shoulder motions simultaneously. The shoulder portion may provide gravity compensation to the upper limb using one or more actuators located in the axilla, as described in greater detail below. The shoulder portion may also provide horizontal flexion compensation to the upper limb using one or more actuators located around the scapula. The shoulder portion may also provide internal/external rotation compensation to the upper limb using ore or more actuators located around the shoulder.

FIG. 1B depicts the elbow portion 140 of the wearable robotic system 100 of FIG. 1A. For applications related to stroke or other neurological rehabilitation, the elbow portion may counteract the effects of the flexor synergy by assisting with elbow extension. The elbow may also be assisted to improve performance during functional tasks. The elbow component 140 shown in FIG. 1B includes a sleeve 143. The sleeve may include both flexible and inflexible materials (e.g., textile materials). For example, the sleeve may include an extensible compression material with select inextensible elements for anchoring. A cutout on the posterior side of the sleeve may both locate and provide pressure relief about the olecranon. A zipper may be included on the upper half of the sleeve to assist with donning. The sleeve 143 may additionally include straps, such as proximal strap 142 and distal strap 144, to enable anchoring to the body and/or adjustments.

The elbow component 140 includes one or more actuators, including a first actuator 146 and a second actuator 148. In some embodiments, the actuators may be textile-based actuators. In some embodiments, the actuators may be fluidic (e.g., pneumatic, hydraulic) actuators. The actuators may include a simple cylindrical geometry, sewn on the anterior side of the elbow, offset on either side of the mid-line, to provide assistance with elbow extension. The actuators may also include a simple cylindrical geometry, sewn on the posterior side of the elbow, offset on either side of the mid-line, to provide assistance with elbow flexion. A pair of actuators may be used, as a single larger actuator located along the mid-line may twist rather than unfold under loading. Furthermore, the inextensible textile of the sleeve between both actuators may act as a sling, evenly distributing the forces of actuation. The anchoring and fit of the actuator may be tuned using straps (not shown) located on either side of the olecranon.

The wearable robot may use an estimate of the user arm kinematics in order to determine the appropriate assistance to provide through the actuators. This estimation can also be used clinically to quantitatively measure short- and long-term changes in kinematics when the wearer is being assisted by the robot, which may assist the therapists in planning and determining personalized goals of the therapy. To enable estimation, a wearable robot may include one or more sensors (e.g., sensors 150 in FIG. 1A) configured to measure a pose of a portion of a wearer of the wearable robotic system. For example, three inertial measurement units (IMUs) may be daisy chained on a CAN-bus and placed on the wearer's torso, upper arm and forearm to measure upper limb pose (shoulder elevation, horizontal flexion, internal-external rotation, and elbow flexion/extension) and torso pose. The IMUs may be placed to approximately align their y-axis parallel to the respectively joints rotation axis. The torso IMU may provide a reference orientation for arm angle estimation. Angle estimation may be performed using rotation matrices or quaternions provided by the internal Kalman filter of the IMUs. In some embodiments, calibration may include a simple static calibration of the rest pose (e.g., arms down along the torso) and in a T-pose (e.g., arm abducted at 90 degrees). Such calibration may be performed on startup to zero any angular offsets due to IMU misalignment with the human joints. While the use of IMUs, rotation matrices and quaternions is described above, it should be appreciated that other appropriate sensors and calculation methods may be used, as the present disclosure is not limited in this regard. As a brief, non-limiting list of examples, appropriate sensors may include strain gauges, stretch sensors, Hall Effect sensors, potentiometers or encoders either independently or together, including together with IMUs.

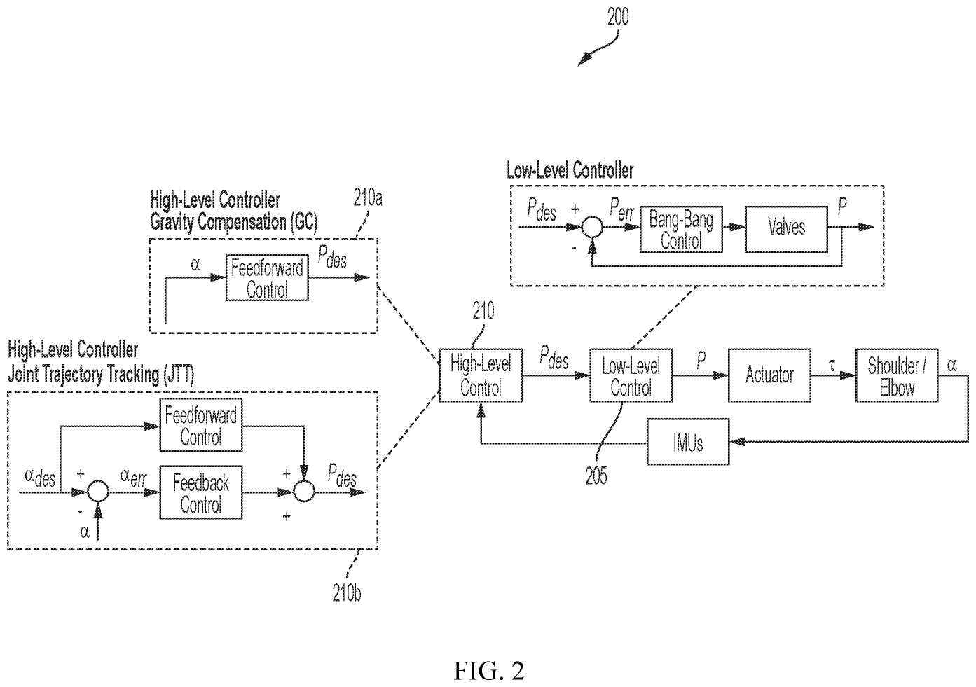

The robot may be controlled using a two-layer architecture, such as the one used in the controller 200 shown in FIG. 2. A low-level control (LLC) loop 205 may manage the internal pressure loop (e.g. via a bang-bang control, or proportional control) of the inlet and outlet valves to the pneumatic actuators. At the same time, a high-level control (HLC) loop 210 may use data from the sensors (e.g., IMUs) to determine a pressure profile to set the reference for the LLC.

As shown in FIG. 2, multiple different HLCs may be implemented. In some embodiments, a Gravity Compensation (GC) control 210a may be used. In some embodiments, a Joint Trajectory Tracking (JTT) control 210b may be used. The controllers may allow for adaptation of the robot assistance to the needs of different users and, in the case of medical applications, to the different recovery statuses of the patients (e.g., during stroke rehabilitation). The JTT controller 210b may be preferable when a wearer has a higher impairment level and would benefit from assistance to initiate and complete any movement. The therapist can easily record the desired trajectory with the wearable robot powered off (due in part to the wearable robot's mechanical transparency), and the wearable robot may then automatically guide the wearer's arm through this programmed trajectory. As the robot guides the arm through the desired motion, the therapist is offloaded and may instead focus on assisting other joints like the wrist or hand, improving the overall effectiveness and quality of the therapy. Alternatively, the JTT could receive a desired trajectory through another means or determining the intent (e.g. with imaging, camera, brain computer interface) or task of the wearer and help move the arm along that path. For wearers who may be able to initiate movements, the GC controller 210a instead allows for intuitive use, more active engagement and more functional therapy.

The GC controller 210a may assist the user by dynamically supporting the estimated gravitational load of the limb. This control strategy may use the shoulder and elbow joint angles, as measured by the sensors (e.g., IMUs), as inputs to a feedforward term which may determine a desired actuator assistance. The feedforward term may additionally command a pressure profile to the LLC. In some embodiments, the feedforward command output can also be scaled to deliver partial gravity compensation.

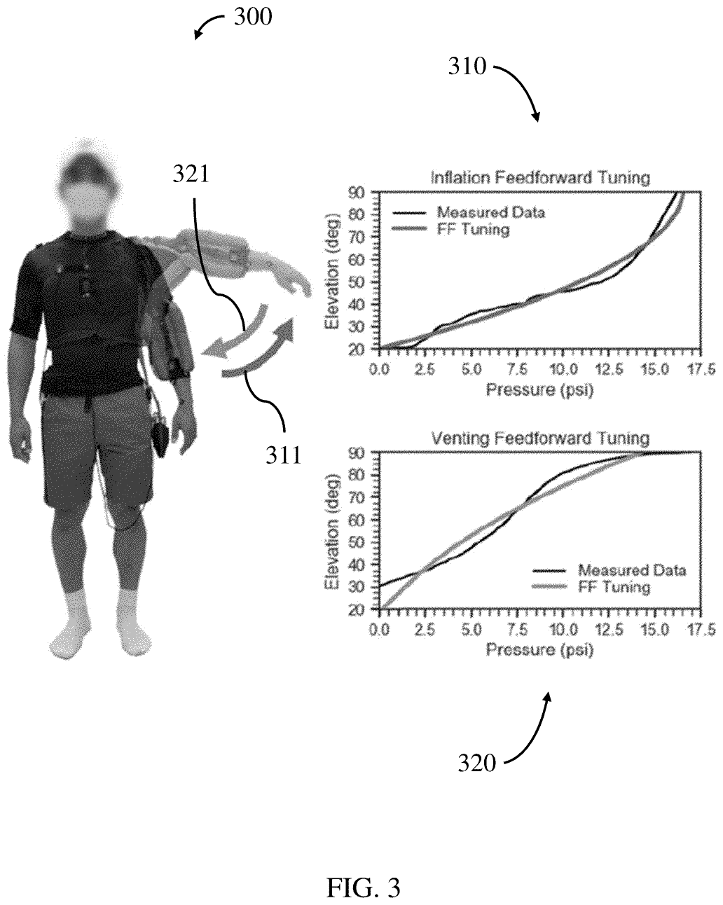

The feedforward term may be determined from a calibration routine as illustrated in FIG. 3. The user wears the wearable robot 300 as the robot is pressurized through a pressure sweep from a vented (zero pressure) condition to a maximum level of pressure (as indicated by arrow 311), and then back to the vented condition (as indicated by arrow 321). During the pressure sweeps (e.g., during inflation and deflation), the users are asked to relax and their arm is passively mobilized by the robot. The pressure of the actuators is recorded both during inflation 310 and venting 320. From these inflation and deflation curves, a correlation between actuator pressure and elevation angle may determined. Accordingly, elevation angle may be controlled by controlling actuator pressure.

Returning to FIG. 2, the JTT controller 210b may assist the user in following a predefined reference trajectory. The JTT controller 210b may be modulated in order to increase or decrease the assistance as needed. In some embodiments, A JTT controller may include a closed loop controller (e.g. PID, MPC, etc.) for each controlled joint (e.g., shoulder elevation and elbow extension) based on the arm angles as measured by the sensors (e.g., IMUs) on the body of the user. The dynamic response of the JTT controller can be improved by including a feedforward term. For example, a JTT controller may include a feedforward term such as the one described above for the GC controller.

### Example: GC Control Test

A GC Control Test was designed to validate the performance of the GC controller. Before beginning controller evaluation, the feedforward term was determined by following the procedure explained above. Participants were asked to cyclically abduct their arm from a rest pose to an elevation of about 90. over the course of 4 s, hold that pose for 4 s and then adduct their arm back to the rest pose over 4 s. The movement speed was controlled using a metronome. The motion duration emulates the typical speed of therapy exercises with the aim of reducing the likelihood of triggering spasticity, which can occur during quick movements.

This cycle was repeated three times for each condition. Assistance is defined as the percentage of the calibrated FF output used to assist the joint, with 100% assistance corresponding to complete gravity compensation of the joint. During the first condition, the participants received no assistance for the first set of movements, during the second condition 50% assistance was delivered, and finally 100% gravity compensation was delivered during the third condition. The elbow actuator was inflated throughout this test to maintain a consistent elbow angle between conditions. During this test, four sEMG sensors recorded the muscle activity in order to verify that the muscles were being offloaded by the robot.

An optical motion capture system with 13 reflective passive markers along the upper-body measured participant's range of motion at 100 Hz. This optical motion capture was used as the ground truth to assess the accuracy of the sensing strategy.

To assess the performance of the GC controller, we measured and compared the muscle activation from the four sEMG sensors between the different conditions (no assistance vs 50% of assistance vs 100%). The sEMG data was sampled at 2 kHz and then processed: first band-pass filtered (4th order, 10-400 Hz), then rectified before passing through a final low pass filter (4th order, 10 Hz). Changes in muscle activation due to assistance from the GC controller acts as a proxy metric to verify that the system does unload the shoulder joint.

The muscle activity of the Middle Deltoid (MD), the primary muscle for shoulder abduction, in response to the GC controller was recorded and analyzed. As expected, the general trend in muscle activity demonstrates that with increased assistance, there were proportionally greater reductions in the MD activity. Minor reductions were also observed in the other measured muscles. The GC controller allowed for meaningful assistance to be provided not just while static but also while the arm was in motion.

Example: JTT Control Test

To begin the JTT Control Test, two different single-joint trajectories were recorded respectively for the shoulder and the elbow. For the shoulder, two elevations 0°→90°→0°, followed by a three-step elevation 0°→45°→90°→45°→0° were performed. A similar profile was requested for the elbow, with the angle moving from about 90° to 180° in this case. The shoulder trajectory was recorded with the participant standing still, while for the elbow, the participants laid supine on a stretcher with their upper arm pointed up in the air to allow for elbow extension against gravity.

During the controller evaluation, participants were asked to remain relaxed within the robot, while the robot control actuated the target joints to reproduce the previously recorded trajectories. The trajectories were replayed with the feedback-only controller, and a combined feedback/feedforward controller using the calibrated feedforward element of the GC controller. During this test, the four sEMG sensors recorded the muscle activity in order to verify that the wearer did not use their muscles. IMU data was used to measure the wearer movement and drive the controller to track the desired joint trajectory. To validate the JTT controller, the RMSE between the desired and the replayed trajectory was computed. Joint angles were collected by using IMUs data only.

The tracking error of the JTT controller was recorded and analyzed. The measured root mean squared error (RMSE) was small for both the tested conditions: the feedback only condition and the feedback plus feedforward condition, with the latter experiencing an expected reduction in RMSE due to the improved dynamic response of the control (better tracking of the transitory phases). The observed improvements due to the feedforward controller may make conducting the simple feedforward calibration worthwhile even if the GC controller is not being used.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

1. A method of calibrating a wearable robot, the method comprising:
adjusting a pressure of a fluidic actuator of the wearable robot;
measuring a joint angle of a wearer of the wearable robot while the pressure of the fluidic actuator is adjusted; and
correlating the joint angle and the pressure of the fluidic actuator.

2. The method of claim 1, wherein:
measuring a joint angle of a wearer of the wearable robot while the pressure of the fluidic actuator is adjusted comprises measuring a first joint angle when the fluidic actuator is pressurized at a first pressure level and measuring a second joint angle when the fluidic actuator is pressurized at a second pressure level; and
correlating the joint angle and the pressure of the fluidic actuator comprises correlating a change from the first joint angle to the second joint angle and a change from the first pressure level to the second pressure level.

3. The method of claim 1, wherein measuring a joint angle of a wearer comprises measuring an angle of a joint of a wearer using one or more sensors.

4. The method of claim 1, wherein the joint is a shoulder joint.

5. The method of claim 4, wherein the measured angle is associated with shoulder flexion and/or extension.

6. The method of claim 4, wherein the measured angle is associated with shoulder horizontal flexion and/or extension.

7. The method of claim 4, wherein the measured angle is associated with shoulder abduction and/or adduction.

8. The method of claim 1, wherein the joint is the elbow joint.

9. The method of claim 8, wherein the measured angle is associated with elbow flexion and/or extension.

10. The method of claim 8, wherein the measured angle is associated with elbow supination and/or pronation.

11. The method of claim 1, wherein the wearable robot is a soft wearable robot.

12. The method of claim 11, wherein the fluidic actuator is a soft fluidic actuator.

13. The method of claim 12, further comprising updating a calibration profile of the soft fluidic actuator based at least partly on the correlation of the joint angles and the pressure of the fluidic actuator.

14. The method of claim 1, wherein the steps of adjusting, measuring, and correlating are conducted for a plurality of joint angles and a plurality of pressures.

15. A method of providing gravity compensation for a wearable robot, the method comprising:
obtaining calibration parameters for the wearable robot, the wearable robot configured to be engaged with first and second body portions of a user on opposing sides of a joint of the user;
estimating a current pose of the first body portion relative to the second body portion; and
operating one or more actuators based on the estimated current pose and the calibration parameters to support at least a portion of a weight of the first body portion.

16. The method of claim 15, wherein operating one or more actuators includes adjusting a pressure of a fluidic actuator of the wearable robot.

17. The method of claim 16, wherein the first body portion of the user is a limb of the user.

18. The method of claim 17, wherein the second body portion is at least a portion of a torso of the user.

19. The method of claim 15, wherein operating one or more actuators includes operating the one or more actuators to control the first body portion of the user through a reference trajectory.

20. The method of claim 19, wherein operating the one or more actuators to control the first body portion of the user through a predefined trajectory includes operating the one or more actuators based on feedback control parameters associated with the reference trajectory.

21. The method of claim 20, wherein the feedback control parameters include one or more kinematic parameters.

22. The method of claim 15, wherein the calibration parameters are determined from a calibration routine.

23. The method of claim 15, wherein the calibration parameters are determined using a black box model.

24. The method of claim 15, wherein the calibration parameters are determined using inverse kinematics.

25. The method of claim 15, further comprising performing the steps of obtaining, estimating, and operating for a plurality of separate joints.

26. A wearable robotic system, the system comprising:
a fluidic actuator;
a pressure source operatively coupled to the fluidic actuator;
one or more sensors configured to measure a pose of a portion of a wearer of the wearable robotic system; and
a processor operatively coupled to the pressure source and the one or more sensors, the processor configured to execute the method of claim 1.
